(19) United States
(12) Patent Application Publication
(10) Pub. No.: US 2026/0080409 A1
(43) Pub. Date: Mar. 19, 2026

(54) DIGITAL IDENTITY VERIFICATION AND GUARANTEE

(71) Applicant: Wells Fargo Bank, N.A., San Francisco, CA (US)

(72) Inventor: Matthew N. Wheeler, Charlotte, NC (US)

(21) Appl. No.: 18/890,012

(22) Filed: Sep. 19, 2024

(51) Int. Cl. G06Q 20/40

(52) U.S. Cl. CPC G06Q 20/4014; G06Q 20/4016

(57) ABSTRACT

Various systems and methods for managing digital identity verification are described herein. A digital identity verification system is configured to receive an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details; determine, based on the consumer identifying information that the consumer is a customer of the digital identity verification system; and in response to determining that the consumer is a customer of the digital identity verification system: determine, based on the consumer identifying information, the business identifying information, and the transaction details, a probability that the consumer is legitimate, the probability represented as a confidence score; determine, based on the confidence score, a fee for a monetary reimbursement for damage to the asset due to the consumer not being legitimate; and transmit an electronic response to the client device, the electronic response including the fee.

### BACKGROUND

Digital identity verification technology is essential for ensuring that individuals are who they claim to be in online interactions, helping to prevent fraud and secure access to services. This technology may employ one or more methods to authenticate users. Knowledge-based verification involves verifying something the user knows, such as passwords or security questions, though this method is increasingly vulnerable to attacks like phishing. Possession-based verification relies on something the user has, such as a smartphone or a one-time password (OTP). Biometric verification uses unique biological traits, such as fingerprints, facial recognition, or iris scans, which are difficult to replicate and provide a high level of security.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating a process for calculating an identity confidence score, according to an embodiment;

FIG. 3 is a flowchart illustrating a method for managing digital identity verification, according to an embodiment; and

FIG. 4 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a service that provides a guaranteed digital identity verification. As e-commerce increases, there is a heightened need for digital identity verification to ensure that parties of a contract can trust each other. The present disclosure provides a system that enables verification or authentication services. The system may be used in various transactions, such as when a buyer and seller transact using a public forum (e.g., Craigslist, Facebook Marketplace, Etsy, classifiedads. com, offerup. com, etc.) or when a consumer rents a property (e.g., Airbnb, Vrbo, Vacasa, private car, boat, RV rentals, etc.). In many of these situations, there is no separate digital identity verification service available. What is needed is a trustworthy, central, and comprehensive digital identity verification service with guarantees.

A transaction may be initiated between a consumer and a platform (e.g., a company that provides advertising for goods or services). The consumer wishes to purchase, rent, or otherwise access or obtain a good or service from a seller through the platform. The present systems and methods provide a reliable third-party identity verification service so the platform can confirm the consumer's identity. The identity verification service can guarantee to the platform that the consumer is who they say they are, and if the seller experiences some loss due to an invalid verification, then the identity verification service may reimburse the seller or the platform for any damages. Identity verification services may be provided by financial institutions, such as banks, insurance companies, or the like. These functions and others are described in more detail below.

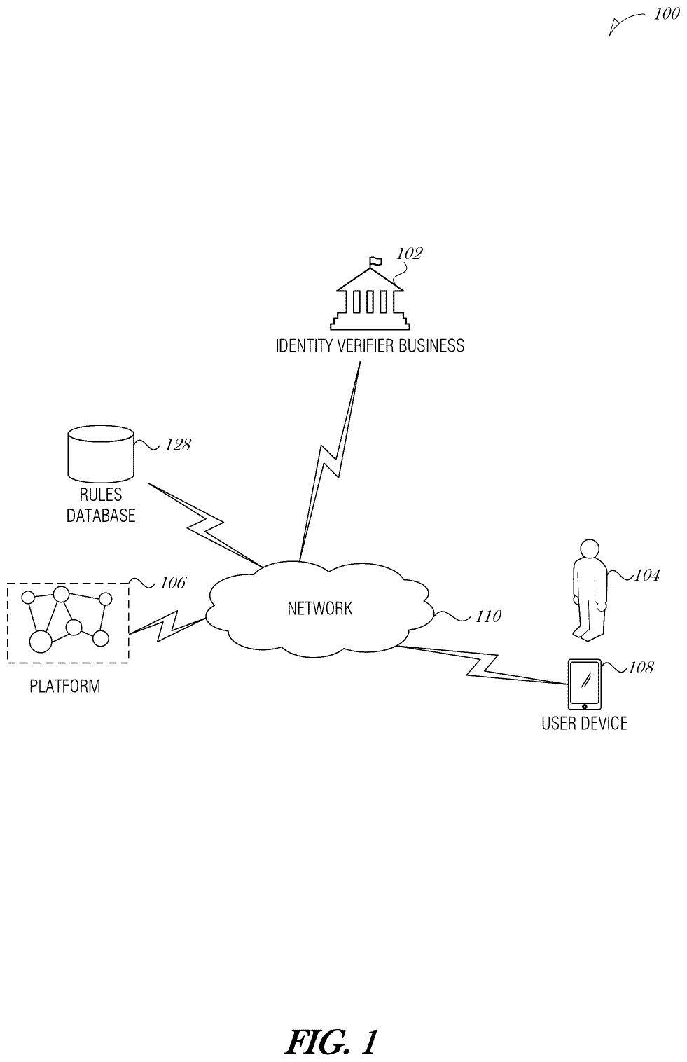

FIG. 1 is a diagram illustrating an operating environment 100, according to an embodiment. An identity verifier business 102 provides a general identity verification service to one or more users 104. The identity verifier business 102 engages with one or more platforms 106. Each platform 106 provides identity verification to the users 104, who may act as either a seller or buyer on the platform 106. The identity verifier business 102, platforms 106, and users 104 interact over a wide-area electronic communication network, such as the Internet.

The identity verifier business 102 may be a financial institution, such as a bank, credit union, insurance company, or the like. The identity verifier business 102 may alternatively be any type of business able to underwrite guarantees provided to the users 104 or platforms 106. Guarantees are provided by the identity verifier business 102 that ensure the platforms 106 and users 104 of the platform that people transacting on the platforms 106 are legitimate and authentic (e.g., who they say they are). If a loss is incurred by the platform 106, and the loss is due to a misidentification of a buyer/renter user 104, then the platform 106 may be reimbursed or made whole by the identity verifier business 102.

The platform 106 provides an online space where buyers and sellers can interact. Examples of services that the platform 106 may provide include short-term or long-term rental of real estate (apartments, houses, farmland, hunting land, recreational land, etc.), vehicles (e.g., recreational vehicles, boats, motorcycles, snowmobiles, etc.), personal items (e.g., power tools, ladders, cameras, drones, laptops, clothing, baby accessories, musical instruments, etc.), ceremonial items (e.g., table and chair sets, party tents, inflatable toys, yard games, etc.), or the like. The platform 106 may provide regional listings of rentable items to potential borrowers. Examples platforms include, but are not limited to Craigslist, Vrbo, Facebook Marketplace, Fat Llama, or other peer-to-peer rental marketplaces.

A seller/lender user 104 can create a listing on a platform 106 advertising a rental opportunity. The rental opportunity may be of any type described here, such as a vacation home, recreational vehicle, etc. The platform 106 may opt in to an identity verification service provided by an identity verifier business 102. The identity verifier business 102 may be a business unit of the platform 106 or a third-party provider to the platform 106. Based on the type of asset being listed, its value, the duration of the rental, or other factors, the platform 106 may request a coverage amount. The platform 106 may have to pay a fee to use the service provided by the identity verifier business 102. The fee is based on the coverage amount and an identity confidence score. The identity confidence score is calculated by the identity verifier business 102 based on numerous factors.

The identity verifier business 102 guarantees that should the person buying or renting cause damage to the asset being listed, and that the person is not actually the person who they held themselves out to be (e.g., identity fraud), then the identity verifier business 102 will reimburse the platform 106 for the damage up to the coverage amount. The reimbursement may be conditional on the platform 106 providing sufficient evidence of the causality of the damage by the buyer/renter user 104 and that the person who caused the damage was a fraudulent identity.

Using a user device 108, a buyer/renter user 104 can book the item listed for some period, such as for a day, a week, or the like. As part of the booking, the buyer/renter user 104 has to provide evidence of their identity for the identity verifier business 102. Evidence may be the form of an image of an identification credential (e.g., license, passport, government issued identification, etc.), an identifier issued by the identity verifier business 102, customer information (e.g., name, address, date of birth (DOB), etc.), customer device information, payment information (e.g., credit card or bank account number, electronic payment identifier, etc.), or the like. Some or all of the evidence may be provided or obtained during an account set up process at the platform 106. Alternatively, some or all of the evidence may be provided or obtained during a checkout process at the platform 106.

The user device 108 may be of any type of compute device including, but not limited to a mobile device, a desktop computer, a smartphone, a laptop computer, a tablet device, a personal digital assistant, a wearable device (e.g., a smartwatch), or the like. The user device 108 may execute an application (app) provided by the identity verifier business 102 to access the accounts and perform tasks.

In an embodiment, the buyer/renter user 104 provides information, such as contact information (e.g., name, mailing address, email address, etc.), personal information (e.g., date of birth (DOB), driver's license number, social security number, etc.), payment information (e.g., credit card number, bank account number, electronic payment platform identifier, etc.), during a checkout process. Additionally, information about the buyer/renter user 104 may be gathered by the platform 106, such as device information of the user device 108 (e.g., device identifier, internet protocol address, GPS position of device, etc.), application information of applications executing on the user device 108 (e.g., web browser type and version, client application type and version, etc.), or transaction information (e.g., the type of good or service being purchased/rented, the location of the good or service, the time or amount of the transaction, the number of transactions in a period, etc.).

Using the information provided and collected about the buyer/renter user 104, the platform 106 constructs a message with a payload and transmits the message and payload to the identity verifier business 102. The message may request an identity verification. The payload may include various transaction information, user information, device information, or the like. The message or payload may also indicate a desired amount of coverage.

The identity verifier business 102 uses the information provided in the payload to perform an identity verification analysis of the buyer/renter user 104. This analysis results in a confidence score. The confidence score is used as a factor in determining a premium for liability insurance offered to the platform (e.g., $25 for up to $25,000 of liability). The seller/lender user 104 is then able to decide whether to pay the premium for the insurance coverage.

The buyer/renter user 104 may be a client of the identity verifier business 102. For instance, the identity verifier business 102 may be a bank and the buyer/renter user 104 may have one or more financial accounts at the identity verifier business 102. This pre-existing relationship between the identity verifier business 102 and the buyer/renter user 104 provides the identity verifier business 102 data to use when calculating the confidence score.

In an example use case, Jane is a mutual customer of a rental platform “RentMyHouse” and a bank, “BigBank.” Jane would like to rent a house through RentMyHouse for a vacation and goes through the reservation process with RentMyHouse. In the process, Jane provides identification information (name, address, phone number, DOB, etc.) and payment information (e.g., credit card information).

RentMyHouse creates a data payload including all the received information about Jane along with Jane's device information (device identifiers, IP address, etc.) and transaction information (dollar amount, dates of travel, location of travel, etc.). RentMyHouse transmits the payload to BigBank and requests BigBank provide a confirmation that the person transacting as Jane is verified as Jane.

BigBank reviews the payload and compares it against known information about Jane because Jane is a customer of BigBank. BigBank generates a confidence score that the RentMyHouse customer is indeed Jane, and based on that confidence score transmits an identity verification metric (e.g., a ranged value like 1-10, a binary value, a score, etc.). Based on the transaction details and the level of confidence of the identity verification, BigBank also creates a liability insurance policy associated with the identity verification. The insurance policy covers the RentMyHouse business financially if it is responsible for someone else's (e.g., the seller/renter party) injuries or property damage. Instead of a general liability insurance policy, the insurance policy provided to RentMyHouse is specific to identity verification in the case of a fraudulent actor.

RentMyHouse can accept or decline the insurance policy. If RentMyHouse accepts the insurance policy and the renter is a fraudster and not Jane, RentMyHouse is able to go back to BigBank to collect on the insurance policy if it experiences damages (e.g., home is damaged, holdover tenant, etc.).

Jane may access the RentMyHouse platform from a web browser, for instance, without having first logging into the BigBank's online system.

Alternatively, Jane may have to access BigBank's system first (e.g., through a mobile application on her mobile device), and then access the RentMyHouse through a link or other user interface control in the BigBank app. In this manner, Jane is authenticated first by the BigBank app (e.g., through biometric identification or username and password), and BigBank is able to confirm that the person accessing the BigBank app is likely Jane. The confidence score can then be calculated using this contextual information. Later, when the user is checking out through the RentMyHouse platform, because of the manner the platform was accessed via the BigBank mobile app, BigBank has additional contextual information about the user's session when calculating the identity verification metric and policy terms.

The identity verifier business 102, platform 106, and user device 108, may be connected via a network 110. The network 110 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The network 110 may include a single local area network (LAN) or wide-area network (WAN), or combinations of LANs or WANs, such as the Internet.

The identity verifier business 102 may expose one or more application programming interfaces (APIs) to the platform 106, user device 108, or other applications. The APIs enable different transactions or microservices. The transactions may be used to request a premium for an identity verification insurance product based on consumer information provided to the platform 106.

The identity verifier business 102 may provision verifier software to the user device 108. The verifier software may be in the form of a mobile application (app). Alternatively, a user 104 may use base software that is provided by other sources (e.g., native software). The base software may include a web browser (e.g., GOOGLE CHROME, APPLE SAFARI, FIREFOX, etc.). The verifier software may be installed as a plug-in to the base software.

The base software or the verifier software is used to access the identity verifier business API using an embedded user interface (UI) within the base software. Calls to the identity verifier business 102 via the API are performed using Hypertext Transfer Protocol (HTTP) messaging protocols, such as with an eXtended Markup Language (XML) Simple Object Access Protocol (SOAP) message or using Representational State Transfer (REST) mechanisms. This modular approach allows business partners, applications, or other software to selectively embed only the services and transactions that they need. Additionally, the use of embedded user interfaces allows for a consistent look and feel to the end user.

One or more microservices may be distributed across hosting regions in the identity verifier business 102 with no shared points of failure for any one functional fault domain. This provides redundancy and resiliency, meaning no two microservices can share the same host, virtual machine (VM), disk, or compute resource. Services may be distributed as being redundant across network resources meaning regionally redundant and accessed by separate circuits. Components within an execution path may be monitored by application performance monitoring tools.

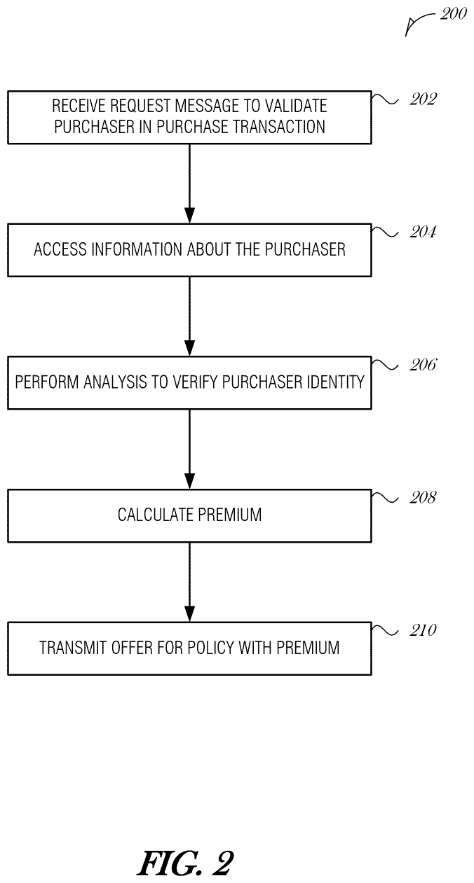

FIG. 2 is a flow diagram illustrating a process 200 for calculating an identity confidence score, according to an embodiment. At operation 202, a request message is received at an identity verifier from an online peer-to-peer marketplace platform. The request message includes transaction details for a transaction at the peer-to-peer marketplace platform. In addition, the message includes a requested coverage amount for the transaction. The request message acts as a request for a quote for a premium for an insurance product in the amount of the coverage.

The transaction details includes various aspects of the transaction, such as a purchaser name, purchaser contact information, a payment credential identifier (e.g., credit card number), a purchase amount, a date and time of the transaction, a description of the item being purchased, a GPS location of a device used by the purchaser at the time of the transaction, etc.

The purchaser at the peer-to-peer marketplace platform is also a customer at the identity verifier. For instance, the person who is the purchaser may also have a financial account at the identity verifier, which is a banking institution. This allows the identity verifier to use information that it has curated about the customer to determine whether the purchaser is the same person as the customer.

At operation 204, the identity verifier accesses information from one or more sources to obtain information about the purchaser. The sources may be external to the identity verifier (e.g., government databases, credit bureau databases, business partner databases, etc.). The sources may include internal customer databases. For instance, the identity verifier may perform a lookup in the customer database by name, social security number, email address, or private personal information that can be used for identification. The customer database may be configured to store past transaction data related to the purchaser/customer. The transactions may be transactions conducted with the identity verifier or with other businesses.

In an implementation, the identity verifier may be a financial institution (e.g., a bank, an insurance company, or the like). The purchaser may be a customer at the financial institution and use a mobile app to access one or more accounts at the financial institution. Information about the customer's activities with the app to access the accounts may be sensed, tracked, or otherwise obtained to be stored at the identity verifier. This information may be used to verify a person's identity.

At operation 206, the identity verifier performs analysis of the information provided by the peer-to-peer marketplace platform about the transaction in view of the information obtained from the one or more sources about the purchaser, to verify the purchaser's identity. The analysis may be performed piece-by-piece, which may be organized into tiers, lists, or groups of importance. The identity verifier may attempt to match each data provided by the peer-to-peer marketplace with a relevant data from the one or more sources. For instance, data may be compared and evaluated in order of first name, last name, date of birth, phone number, email address, mailing address, and zip code. This order of comparisons emphasizes the importance of the person's name over their mailing address, and the person's date of birth over a zip code. It is understood that other rankings may be used to change the order of the data under analysis. Data is compared and it is determined how similar they are to one another. This is continued for data fields that correlate. Various functions may be used, such as an average, a weighted function, or other function to combine the similarity scores into an aggregate score, or confidence score.

In another example, the data may be compared using a machine learning (ML) system. An ML system may be trained using transaction data, customer purchasing data, customer demographic data, etc. Based on input data about a person and a transaction, the ML system can output a likelihood that the person is not a fraudster or imposter. This probability represents the confidence that the ML system has that the person is legitimate, or a confidence score.

As an illustrative example of the process 200, Sally may interface with an online booking platform (e.g. “BoatsForRent”) to book a rental of a boat for a week in April. By cross-referencing data about Sally, an identity verification service is able to determine whether that the person initiating the transaction is Sally. The identity verification service identifies that the rental is located in Clearwater, Florida, where Sally has vacationed before. The rental is in April, which aligns with Sally's previous vacation times to Florida. The transaction occurred in the middle of the afternoon during a business day, which is reasonable. The GPS location of the device that was used to make the booking was located in a building near where Sally works and where she has accessed the identity verification service before as a customer of the identity verification service or an affiliated business. The amount of the transaction is consistent with past rentals made by Sally. Based on these comparisons and inferences, the identity verification service is able to calculate a confidence score of 90%. The identity verification service is then able to offer one or more identity verification insurance policies to the BoatsForRent platform.

At operation 208, a premium for a policy is calculated. To determine the premium for a policy, actuarial analysis may be used. As part of the analysis to determine the premium for a given policy of a given coverage amount and a given term, the identity verification service may also scale a base premium based on the confidence score. A higher confidence score implies lower risk and as such, a lower premium. Conversely, a lower confidence score implies higher risk that the person is an imposter, and a higher premium. If the confidence score is below a threshold, the transaction may be non-insurable.

At operation 210, the identity verifier transmits one or more offers of policies to the peer-to-peer marketplace platform. Optionally, the identity verifier may also transmit the calculated confidence score. The confidence score may be used by the peer-to-peer marketplace platform for various business processes, such as to display it for the buyer or seller, use it for its own risk analysis, or the like.

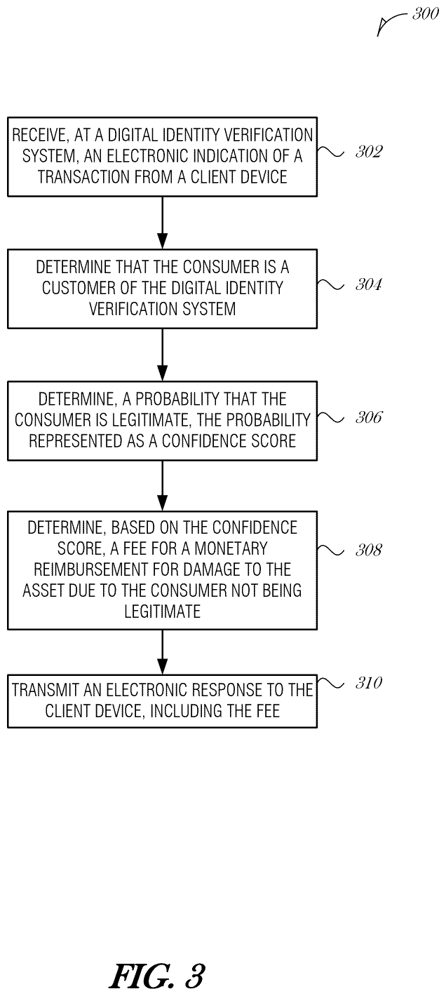

FIG. 3 is a flowchart illustrating a method 300 for managing digital identity verification, according to an embodiment. The method 300 may be performed by an electronic system (e.g., platform 106) or any of the modules, logic, circuits, processors, or components described herein.

At 302, the method 300 includes the operation of receiving, at a digital identity verification system, an electronic indication of a transaction from a client device. The transaction is for a rental or purchase of an asset. The electronic indication includes consumer identifying information to identify a consumer of the asset, business identifying information to identify a business from whom the consumer is renting or purchasing the asset, and transaction details. In an embodiment, the digital identity verification system is a financial institution.

In an embodiment, the electronic indication of the transaction is a Hypertext Transfer Protocol (HTTP) message request for the fee for the monetary reimbursement. In a further embodiment, the amount of the monetary reimbursement is set by the business. In another embodiment, the Hypertext Transfer Protocol (HTTP) message request is an eXtended Markup Language (XML) Simple Object Access Protocol (SOAP) message. In a further embodiment, the Hypertext Transfer Protocol (HTTP) message request is a Representational State Transfer (REST) message. In an embodiment, the electronic indication of the transaction includes the monetary reimbursement.

In an embodiment, the electronic indication of the transaction is received through an application programming interface (API) exposed to the client device, wherein the API exposes a number of services provided by the digital identity verification system.

At 304, the method 300 includes the operation of determining, based on the consumer identifying information that the consumer is a customer of the digital identity verification system. If the consumer is not a customer of the digital identity verification system, then the method 300 ends and the digital identity verification system may respond with a message indicating failure.

In response to determining that the consumer is a customer of the digital identity verification system, at 306, the method 300 includes the operation of determining, based on the consumer identifying information, the business identifying information, and the transaction details, a probability that the consumer is legitimate. The probability is represented as a confidence score.

In an embodiment, the consumer identifying information includes a first name of the consumer, a last name of the consumer, a date of birth of the consumer, or a ZIP code of the consumer.

In an embodiment, determining the probability that the consumer is legitimate includes retrieving consumer data of the consumer from a database internal to the digital identity verification system, comparing the consumer data from the database to data from the electronic indication of the transaction, and calculating the probability based on the similarity of the consumer data to the data from the electronic indication of the transaction. In a further embodiment, comparing the consumer data from the database to data from the electronic indication of the transaction includes using a machine-learning system to perform the comparison. In another embodiment, the consumer data includes transaction data of transactions between the consumer and the digital identity verification system.

At 308, the method 300 includes the operation of determining, based on the confidence score, a fee for a monetary reimbursement for damage to the asset due to the consumer not being legitimate.

At 310, the method 300 includes the operation of transmitting an electronic response to the client device, the electronic response including the fee.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

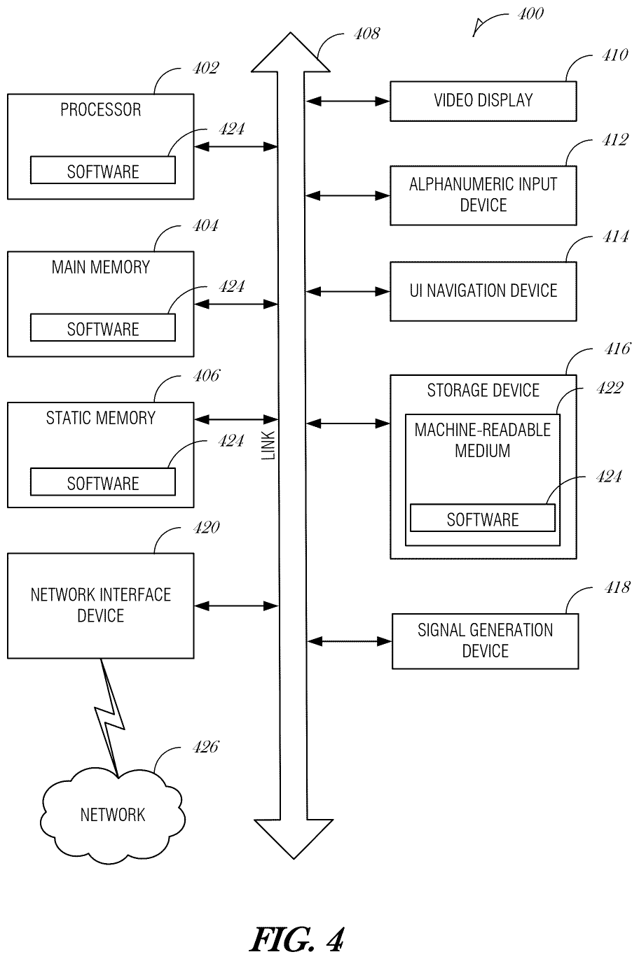

FIG. 4 is a block diagram illustrating a machine in the example form of a computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a digital identity verification system, the system comprising: a processor subsystem; and memory including instructions, which when executed by the processor subsystem, cause the processor subsystem to: receive an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details; determine, based on the consumer identifying information that the consumer is a customer of the digital identity verification system; and in response to determining that the consumer is a customer of the digital identity verification system: determine, based on the consumer identifying information, the business identifying information, and the transaction details, a probability that the consumer is legitimate, the probability represented as a confidence score; determine, based on the confidence score, a fee for a monetary reimbursement for damage to the asset due to the consumer not being legitimate; and transmit an electronic response to the client device, the electronic response including the fee.

In Example 2, the subject matter of Example 1 includes, wherein the consumer identifying information includes a first name of the consumer, a last name of the consumer, a date of birth of the consumer, or a ZIP code of the consumer.

In Example 3, the subject matter of Examples 1-2 includes, wherein the electronic indication of the transaction is a Hypertext Transfer Protocol (HTTP) message request for the fee for the monetary reimbursement.

In Example 4, the subject matter of Example 3 includes, wherein the amount of the monetary reimbursement is set by the business.

In Example 5, the subject matter of Examples 3-4 includes, wherein the Hypertext Transfer Protocol (HTTP) message request is an eXtended Markup Language (XML) Simple Object Access Protocol (SOAP) message.

In Example 6, the subject matter of Example 5 includes, wherein the Hypertext Transfer Protocol (HTTP) message request is a Representational State Transfer (REST) message.

In Example 7, the subject matter of Examples 1-6 includes, wherein the electronic indication of the transaction is received through an application programming interface (API) exposed to the client device, wherein the API exposes a number of services provided by the digital identity verification system.

In Example 8, the subject matter of Examples 1-7 includes, wherein to determine the probability that the consumer is legitimate, the memory includes instructions, which when executed by the processor subsystem, cause the processor subsystem to: retrieve consumer data of the consumer from a database internal to the digital identity verification system; compare the consumer data from the database to data from the electronic indication of the transaction; and calculate the probability based on the similarity of the consumer data to the data from the electronic indication of the transaction.

In Example 9, the subject matter of Example 8 includes, wherein to compare the consumer data from the database to data from the electronic indication of the transaction, the memory includes instructions, which when executed by the processor subsystem, cause the processor subsystem to use a machine-learning system to perform the comparison.

In Example 10, the subject matter of Examples 8-9 includes, wherein the consumer data includes transaction data of transactions between the consumer and the digital identity verification system.

In Example 11, the subject matter of Examples 1-10 includes, wherein the digital identity verification system is a financial institution.

In Example 12, the subject matter of Examples 1-11 includes, wherein the electronic indication of the transaction includes the monetary reimbursement.

Example 13 is a method for managing digital identity verification, the method performed on an electronic online system, the method comprising: receiving, at a digital identity verification system, an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details; determining, based on the consumer identifying information, the business identifying information, and the transaction details, a probability that the consumer is legitimate, the probability represented as a confidence score; determining, based on the confidence score, a fee for a monetary reimbursement for damage to the asset due to the consumer not being legitimate; and transmitting an electronic response to the client device, the electronic response including the fee.

In Example 14, the subject matter of Example 13 includes, wherein the consumer identifying information includes a first name of the consumer, a last name of the consumer, a date of birth of the consumer, or a ZIP code of the consumer.

In Example 15, the subject matter of Examples 13-14 includes, wherein the electronic indication of the transaction is a Hypertext Transfer Protocol (HTTP) message request for the fee for the monetary reimbursement.

In Example 16, the subject matter of Example 15 includes, wherein the amount of the monetary reimbursement is set by the business.

In Example 17, the subject matter of Examples 15-16 includes, wherein the Hypertext Transfer Protocol (HTTP) message request is an eXtended Markup Language (XML) Simple Object Access Protocol (SOAP) message.

In Example 18, the subject matter of Example 17 includes, wherein the Hypertext Transfer Protocol (HTTP) message request is a Representational State Transfer (REST) message.

In Example 19, the subject matter of Examples 13-18 includes, wherein the electronic indication of the transaction is received through an application programming interface (API) exposed to the client device, wherein the API exposes a number of services provided by the digital identity verification system.

In Example 20, the subject matter of Examples 13-19 includes, wherein determining the probability that the consumer is legitimate comprises: retrieving consumer data of the consumer from a database internal to the digital identity verification system; comparing the consumer data from the database to data from the electronic indication of the transaction; and calculating the probability based on the similarity of the consumer data to the data from the electronic indication of the transaction.

In Example 21, the subject matter of Example 20 includes, wherein comparing the consumer data from the database to data from the electronic indication of the transaction comprises using a machine-learning system to perform the comparison.

In Example 22, the subject matter of Examples 20-21 includes, wherein the consumer data includes transaction data of transactions between the consumer and the digital identity verification system.

In Example 23, the subject matter of Examples 13-22 includes, wherein the digital identity verification system is a financial institution.

In Example 24, the subject matter of Examples 13-23 includes, wherein the electronic indication of the transaction includes the monetary reimbursement.

Example 25 is a non-transitory machine-readable medium comprising instructions for managing digital identity verification, which when executed by a machine in an online system cause the machine to: receive, at a digital identity verification system, an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details; determine, based on the consumer identifying information, the business identifying information, and the transaction details, a probability that the consumer is legitimate, the probability represented as a confidence score; determine, based on the confidence score, a fee for a monetary reimbursement for damage to the asset due to the consumer not being legitimate; and transmit an electronic response to the client device, the electronic response including the fee.

In Example 26, the subject matter of Example 25 includes, wherein the consumer identifying information includes a first name of the consumer, a last name of the consumer, a date of birth of the consumer, or a ZIP code of the consumer.

In Example 27, the subject matter of Examples 25-26 includes, wherein the electronic indication of the transaction is a Hypertext Transfer Protocol (HTTP) message request for the fee for the monetary reimbursement.

In Example 28, the subject matter of Example 27 includes, wherein the amount of the monetary reimbursement is set by the business.

In Example 29, the subject matter of Examples 27-28 includes, wherein the Hypertext Transfer Protocol (HTTP) message request is an eXtended Markup Language (XML) Simple Object Access Protocol (SOAP) message.

In Example 30, the subject matter of Example 29 includes, wherein the Hypertext Transfer Protocol (HTTP) message request is a Representational State Transfer (REST) message.

In Example 31, the subject matter of Examples 25-30 includes, wherein the electronic indication of the transaction is received through an application programming interface (API) exposed to the client device, wherein the API exposes a number of services provided by the digital identity verification system.

In Example 32, the subject matter of Examples 25-31 includes, wherein to determine the probability that the consumer is legitimate, the memory includes instructions, which when executed by the processor subsystem, cause the processor subsystem to: retrieve consumer data of the consumer from a database internal to the digital identity verification system; compare the consumer data from the database to data from the electronic indication of the transaction; and calculate the probability based on the similarity of the consumer data to the data from the electronic indication of the transaction.

In Example 33, the subject matter of Example 32 includes, wherein to compare the consumer data from the database to data from the electronic indication of the transaction, the memory includes instructions, which when executed by the processor subsystem, cause the processor subsystem to use a machine-learning system to perform the comparison.

In Example 34, the subject matter of Examples 32-33 includes, wherein the consumer data includes transaction data of transactions between the consumer and the digital identity verification system.

In Example 35, the subject matter of Examples 25-34 includes, wherein the digital identity verification system is a financial institution.

In Example 36, the subject matter of Examples 25-35 includes, wherein the electronic indication of the transaction includes the monetary reimbursement.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A digital identity verification system, the system comprising:
a processor subsystem; and
memory including instructions, which when executed by the processor subsystem, cause the processor subsystem to:
receive an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details;
determine, based on the consumer identifying information that the consumer is a customer of the digital identity verification system; and
in response to determining that the consumer is a customer of the digital identity verification system:
determine, based on the consumer identifying information, the business identifying information, and the transaction details, a probability that the consumer is legitimate, the probability represented as a confidence score;
determine, based on the confidence score, a fee for a monetary reimbursement for damage to the asset due to the consumer not being legitimate; and
transmit an electronic response to the client device, the electronic response including the fee.

2. The system of claim 1, wherein the consumer identifying information includes a first name of the consumer, a last name of the consumer, a date of birth of the consumer, or a ZIP code of the consumer.

3. The system of claim 1, wherein the electronic indication of the transaction is a Hypertext Transfer Protocol (HTTP) message request for the fee for the monetary reimbursement.

4. The system of claim 3, wherein the amount of the monetary reimbursement is set by the business.

5. The system of claim 3, wherein the Hypertext Transfer Protocol (HTTP) message request is an eXtended Markup Language (XML) Simple Object Access Protocol (SOAP) message.

6. The system of claim 5, wherein the Hypertext Transfer Protocol (HTTP) message request is a Representational State Transfer (REST) message.

7. The system of claim 1, wherein the electronic indication of the transaction is received through an application programming interface (API) exposed to the client device, wherein the API exposes a number of services provided by the digital identity verification system.

8. The system of claim 1, wherein to determine the probability that the consumer is legitimate, the memory includes instructions, which when executed by the processor subsystem, cause the processor subsystem to:
retrieve consumer data of the consumer from a database internal to the digital identity verification system;
compare the consumer data from the database to data from the electronic indication of the transaction; and
calculate the probability based on the similarity of the consumer data to the data from the electronic indication of the transaction.

9. The system of claim 8, wherein to compare the consumer data from the database to data from the electronic indication of the transaction, the memory includes instructions, which when executed by the processor subsystem, cause the processor subsystem to use a machine-learning system to perform the comparison.

10. The system of claim 8, wherein the consumer data includes transaction data of transactions between the consumer and the digital identity verification system.

11. The system of claim 1, wherein the digital identity verification system is a financial institution.

12. The system of claim 1, wherein the electronic indication of the transaction includes the monetary reimbursement.

13. A method for managing digital identity verification, the method performed on an electronic online system, the method comprising:
receiving, at a digital identity verification system, an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details;
determining, based on the consumer identifying information, the business identifying information, and the transaction details, a probability that the consumer is legitimate, the probability represented as a confidence score;
determining, based on the confidence score, a fee for a monetary reimbursement for damage to the asset due to the consumer not being legitimate;
and transmitting an electronic response to the client device, the electronic response including the fee.

14. The method of claim 13, wherein the electronic indication of the transaction is a Hypertext Transfer Protocol (HTTP) message request for the fee for the monetary reimbursement.

15. The method of claim 14, wherein the Hypertext Transfer Protocol (HTTP) message request is an eXtended Markup Language (XML) Simple Object Access Protocol (SOAP) message.

16. The method of claim 13, wherein determining the probability that the consumer is legitimate comprises:
retrieving consumer data of the consumer from a database internal to the digital identity verification system;
comparing the consumer data from the database to data from the electronic indication of the transaction; and
calculating the probability based on the similarity of the consumer data to the data from the electronic indication of the transaction.

17. The method of claim 16, wherein comparing the consumer data from the database to data from the electronic indication of the transaction comprises using a machine-learning system to perform the comparison.

18. The method of claim 16, wherein the consumer data includes transaction data of transactions between the consumer and the digital identity verification system.

19. A non-transitory machine-readable medium comprising instructions for managing digital identity verification, which when executed by a machine in an online system cause the machine to:
receive, at a digital identity verification system, an electronic indication of a transaction from a client device, the transaction being for a rental or purchase of an asset, the electronic indication including consumer identifying information to identify a consumer of the asset, business identifying information to identify a business from whom the consumer is renting or purchasing the asset, and transaction details;
determine, based on the consumer identifying information, the business identifying information, and the transaction details, a probability that the consumer is legitimate, the probability represented as a confidence score;
determine, based on the confidence score, a fee for a monetary reimbursement for damage to the asset due to the consumer not being legitimate; and
transmit an electronic response to the client device, the electronic response including the fee.

20. The non-transitory machine-readable medium of claim 19, wherein the electronic indication of the transaction includes the monetary reimbursement.
